(19) United States
(12) Patent Application Publication
(10) Pub. No.: US 2014/0264993 A1
(43) Pub. Date: Sep. 18, 2014

(54) METHODS FOR BLOW MOLDING SOLID-STATE CELLULAR THERMOPLASTIC ARTICLES

(71) Applicants: University of Washington through its Center for Commercialization, Seattle, WA (US); MicroGREEN Polymers, Inc., Arlington, WA (US)

(72) Inventors: Krishna V. Nadella, Redmond, WA (US); Vipin Kumar, Seattle, WA (US); Nicholas C. Lewis, Everett, WA (US); Matthew D. Medzegian, Renton, WA (US); Benjamin W. Morgan, Jr., Santa Clara, CA (US); Kevin D. Murray, Seattle, WA (US)

(21) Appl. No.: 13/830,920

(22) Filed: Mar. 14, 2013

(51) Int. Cl. B29C 44/34

(52) U.S. Cl. CPC B29C 44/3403
USPC 264/51

(57) ABSTRACT

Methods for saturating a plurality of parisons simultaneously with a saturating gas are disclosed. The parisons may be saturated using a sealed elongated tube through which the parisons are transferred. Parisons may be stacked vertically or horizontally using modular trays, and then loaded into pressure vessels. Parisons may be saturated in individual pressure vessels which are re-pressurized at various intervals. The gas-saturated parisons can be re-heated and blow molded to provide cellular blow-molded articles.

### BACKGROUND

Blow molding is a manufacturing process used to produce hollow articles from thermoplastic polymers. Blow molding is used in the production of hollow articles. Blow molding can include extrusion blow molding, injection blow molding, and stretch blow molding. Typically, the blow molding process begins with melting a thermoplastic material and extruding the melt into a hollow form called a parison. A mold is clamped around the parison, and before the parison solidifies, air or a gaseous medium is pumped into the parison. The pressure pushes the parison outward to assume the shape of the mold. The polymer can be cooled by recirculating water within the mold. Once the polymer has solidified, the mold is opened up and the article is ejected. In some cases, the parisons are allowed to solidify before being blow molded. In these cases, the parisons are reheated and then blow molded.

Blow molded cellular articles can be made by introducing a foaming agent into the melted extrusion used to make the parison. The cell size and uniformity are controlled by altering the foaming agent, pressure and temperature of the extrusion, and changes to the mixing portion of the extruder. Recently, a solid-state foaming process has been used with blow molding. U.S. Pat. No. 8,168,114 and U.S. Patent Application Publication No. 20120183710 disclose the use of solid state foaming with blow molding processes, both of which are incorporated herein expressly by reference. A solid state foaming process generally involves the saturation of thermoplastic materials with gas while the material is a solid and then heating the material to point where the material softens, but is not melted (i.e., remains a solid). The heating of the gas-saturated solid material generates the cells.

If solid-state foaming is to be used with blow molding, a problem arises in that saturating a large number of parisons can be difficult. Disclosed are systems for saturating parisons in a manner that is efficient and that can be used to saturate parisons on a large scale.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a method for saturating parisons with a saturating gas sufficient to foam when heated includes the steps, placing gas-unsaturated parisons at one end of a tube, wherein the parisons are arranged longitudinally end to end within the tube; pressurizing the tube with a saturating gas; transferring the parisons within the tube with the saturating gas for a period of time sufficient to saturate the parisons with the gas, and removing gas-saturated parisons at an opposite end of the tube.

In some embodiments, the gas is substantially 100% carbon dioxide.

In some embodiments, the parisons are substantially 100% polyethylene terephthalate.

In some embodiments, the tube includes at least one inner perforated tube within an outer tube, wherein the parisons are transferred in the inner tube.

Is some embodiments, a method of saturating parisons with a saturating gas sufficient to foam when heated includes the steps of stacking trays containing vertically aligned parisons on a rack, wherein each parison has a body with two ends, and wherein the parisons are supported by either end in holes in the trays; placing the parisons assembled on the trays in a pressure vessel, wherein the longitudinal axes of the parisons are substantially vertical; pressurizing the pressure vessel with a saturating gas; and saturating the parisons with the gas sufficient to create cells in the parisons when heated.

In some embodiments, the parisons comprise a neck connected to an open end of the body, with the parisons being supported by their necks in the holes in the trays, and wherein a closed end of a parison nests within an open neck of an adjacent lower parison.

In some embodiments, each tray is similar and comprises a plurality of holes larger than a size of the parison body and smaller than a size of the neck, and each tray comprises legs extending vertically to support one tray on top of another.

In some embodiments, each tray includes one or more holes matching a size of a vertically placed alignment arm extending upright from a base.

In some embodiments, the parisons are substantially 100% polyethylene terephthalate.

In some embodiments, the saturating gas is substantially 100% carbon dioxide.

In some embodiments, a closed end of one parison does not touch the inside of a neck of an adjacent parison when nested.

In some embodiments, a parison includes a neck with a ridge that supports the parison from the tray.

In some embodiments, a method for saturating parisons with a saturating gas sufficient to foam when heated includes the steps, stacking trays containing horizontally aligned parisons, wherein each parison has a body with two ends, and each parison is supported by both ends with a first perforated loading tray at one end, and a second perforated lid tray at the other end; placing the parisons assembled on the trays in a pressure vessel, wherein the longitudinal axes of the parisons are substantially horizontal; pressurizing the pressure vessel with a saturating gas; and saturating the parisons with the gas sufficient to create cells in the parisons when heated.

In some embodiments, each parison comprises a neck connected to an open end of the body and a closed end, and wherein the first loading tray supports the necks of parisons and the second lid tray supports the closed ends of parisons, and wherein the closed end of a parison nests within an open neck of an adjacent parison.

In some embodiments, the first perforated loading tray has holes larger than the second perforated lid tray. In some embodiments, the holes of both trays are the same.

In some embodiments, the first perforated loading tray comprises support legs to rest on an adjacent perforated lid tray, and the lid tray comprises a rim around a periphery that extends perpendicular to the lid tray, wherein the rim fits on the periphery of an adjacent first loading tray.

In some embodiments, the parisons are substantially 100% polyethylene terephthalate.

In some embodiments, the saturating gas is substantially 100% carbon dioxide.

In some embodiments, each parison has a closed end and an open end with a neck, and the closed end of one parison does not touch the inside of the neck of an adjacent parison when nested.

In some embodiments, a method for saturating parisons with a saturating gas sufficient for foaming includes the steps, placing a gas-unsaturated parison in a pressure vessel individually; pressurizing the pressure vessel with the parison with a saturating gas; periodically re-pressurizing the pressure vessel as the parison absorbs the gas; transferring the pressure vessel with the parison for a period sufficient to achieve a concentration of gas sufficient to create cells in the parison when heated; and removing the gas-saturated parison from the pressure vessel.

In some embodiments, the parison is substantially 100% polyethylene terephthalate.

In some embodiments, the saturating gas is substantially 100% carbon dioxide.

In some embodiments, the parison comprises an elongated body portion closed at one end, and a neck portion of a larger diameter connected to an open end of the body portion.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a flow diagram of an injection blow molding process and a stretch blow molding process using an extrusion process;

FIG. 2 shows a flow diagram of an injection blow molding process and a stretch blow molding process using solid state foaming;

FIG. 3 is a diagrammatical illustration of a system for saturating parisons;

FIG. 4 is a diagrammatical illustration of apparatus for saturating parisons;

FIG. 5 is a diagrammatical illustration of apparatus for saturating parisons;

FIG. 6 is a diagrammatical illustration of apparatus for saturating parisons;

FIG. 7 is a diagrammatical illustration of apparatus for saturating parisons;

FIG. 8 is a diagrammatical illustration of apparatus for saturating parisons;

FIG. 9 is a diagrammatical illustration of apparatus for saturating parisons;

FIG. 10 is a diagrammatical illustration of apparatus for saturating parisons;

FIG. 11 is a diagrammatical illustration of apparatus for saturating parisons;

FIG. 12 is a diagrammatical illustration of apparatus for saturating parisons;

FIG. 13 is a diagrammatical illustration of apparatus for saturating parisons;

FIG. 14 is a diagrammatical illustration of apparatus for saturating parisons;

FIG. 15 is a diagrammatical illustration of a system for saturating parisons;

FIG. 16 is a diagrammatical illustration of apparatus for saturating parisons;

FIG. 17 is a diagrammatical illustration of apparatus for saturating parisons;

FIG. 18 is a diagrammatical illustration of apparatus for saturating parisons;

FIG. 19 is a diagrammatical illustration of apparatus for saturating parisons;

FIG. 20 is a diagrammatical illustration of a system for saturating parisons;

FIG. 21 is a diagrammatical illustration of apparatus for saturating parisons;

FIG. 22 is a diagrammatical illustration of apparatus for saturating parisons; and

FIG. 23 is a diagrammatical illustration of apparatus for saturating parisons.

### DETAILED DESCRIPTION

The disclosure relates to a process for producing blow molded cellular articles from a solid thermoplastic material. The disclosure particularly provides methods and apparatus for the saturation of solid parisons with a non-reacting saturating gas. The gas-saturated parisons can then be used to create cellular articles via blow molding processes.

The process of blow molding, as diagramed in FIG. 1, can be used for the production of hollow solid thermoplastic articles, such as bottles and jars. First, molten thermoplastic material 10 from an extruder is injected into a heated preform mold 15 around a hollow mandrel blow tube to provide a parison 20. The preform mold forms the external shape of the parison. The parison is clamped around the mandrel, which forms the internal shape of the parison. The parison usually includes a fully formed bottle/jar neck with a thick hollow body attached. The body is usually closed at one end and connected to the neck at the opposite open end. The unsolidified parison is placed in a larger blow mold for blow molding 25. The parison is expanded with, for example, compressed air to achieve the finished article shape. After a cooling period 30, the mold opens and the finished shaped solid noncellular thermoplastic article 35 is removed from the assembly.

Depending on the thermoplastic material, the parison may undergo a cooling step between the parison production step and the blow molding step. This is because the material may not have the strength to go directly from a molten state to a blow molding process. Such parison is allowed to cool and then must be re-heated to be blow molded. In some instances, parisons are allowed to solidly and cool completely. This is the case where stock parisons are manufactured separately from blow molded articles. For example, a manufacturer may exclusively manufacture parisons without performing blow molding. Similarly, a blow molding manufacturer may exclusively produce blow molded articles without undertaking the manufacture of parisons. The parison manufacturer can provide a variety of parisons to the blow molding manufacturer, which converts the parisons into finished blow molded articles. In this way, the blow molding manufacturer does not need to obtain the extrusion and injection molding equipment to make the parisons, and the parison manufacture does not need to invest in the blow molding equipment.

Stretch blow molding is a variation of blow molding in which a parison is elongated mechanically in the blow mold and then expanded radially in a blowing process. Still referring to FIG. 1, in the stretch blow molding process, the molten thermoplastic material 10 flows into the heated mold 15 via a hot runner block to produce the desired shape of the preformed parison 20 with a mandrel producing the inner diameter and the preform mold producing the outer shape. Where the preforms are manufactured separately from the blow molded articles, these preformed parisons can be cooled, solidified, and packaged. Once at the blow molding manufacturer, the preformed parison is re-heated, typically via the use of infrared heaters, above its glass transition temperature. Then, the heated parison is placed in a blow mold, and the parison is blown into the finished article using high pressure air while being stretched with a plunger 40. The stretching of some thermoplastic materials, such as polyethylene terephthalate, results in strain hardening of the material.

The disclosed process modifies the traditional blow molding and stretch blow molding processes by saturating the solid (nonmolten) and noncellular parison with a saturating gas before the parison is re-heated and blow molded. For example, the solid noncellular parison can be made in the conventional manner, but is then treated with a saturating gas. The saturating gas is caused to saturate the parison by placing the parison in a pressure vessel, which is then pressurized with the saturating gas. The saturating gas achieves a sufficient concentration within the parison to allow for solid-state foaming during the re-heating of the parison in preparation for blow molding.

A blowmolding process using solid-state foaming is illustrated in FIG. 2. In the solid-state foaming, foaming occurs while the polymer remains in the solid state. Solid-state foaming differs from other polymer foaming processes because the polymer is not required to be in a molten state for foaming to occur.

FIG. 2 shows a flow diagram of a method for solid state foaming and blow molding. A solid and noncellular preformed parison 100 is obtained. The preformed parison 100 can be made according to the description described above in connection with FIG. 1. The thermoplastic material can be any single thermoplastic polymer or a mixture of thermoplastic polymers including, but not limited to, polycarbonate, polypropylene, polyethylene, polyethylene terephthalate, polyvinyl chloride, poly(lactic acid), acrylonitrile butadiene styrene, and polystyrene, including low density polyethylene (LDPE), high density polyethylene (HDPE). Parisons can be made from the aforementioned thermoplastic material using processes well-known in the plastics industry. In some embodiments, the parisons are substantially 100% by weight poly(ethylene terephthalate). Parisons can be made from a substantially 100% by weight single material, or a combination of one or more thermoplastic materials, wherein the combined total is substantially 100% by weight. “Substantially 100% by weight” is used to encompass any commercially available thermoplastic, such as poly(ethylene terephthalate), that may include impurities.

From block 100, the process enters block 110. In block 110, the solid and noncellular parison is treated at an elevated gas pressure with a saturating gas. That is, the saturating gas produces the elevated pressure. As used herein, a saturating gas may include carbon dioxide, nitrogen, argon, and inert gases, or any combination thereof. The saturating gas can be substantially 100% by weight of any single gas, or a combination of gases. In some embodiments, the saturating gas is substantially 100% by weight carbon dioxide. The treatment of the solid parison at an elevated gas pressure causes the thermoplastic material to absorb the saturating gas, leading to a gas-saturated parison. The treatment can proceed to complete saturation followed by a step for desorption, or alternatively, the treatment can proceed to partial saturation followed by a step for desorption. Desorption can be incidental to the process or an intentional step in the process. Desorption naturally occurs when a gas-saturated parison at an elevated gas pressure is introduced into an atmosphere of lower pressure, such as would occur when removing a gas-saturated parison from a pressurized vessel to atmospheric pressure. If the desorption is incidental, then the desorption period is the time from removal of the gas-saturated parison from the pressure vessel until the time the gas-saturated parison is heated. Desorption results in lower gas concentrations at the exterior surface. This can be used to create solid exterior surfaces since the gas concentration is insufficient to create a cellular structure. When treating the parisons with the saturating gas, the elevated gas pressure may be from about 3 MPa to about 7.5 MPa and any values inbetween. In one embodiment, the elevated pressure is about 4 MPa. In another embodiment, the elevated pressure is about 5 MPa.

The treatment of the solid parison in block 110 may be carried out in a pressure vessel filled with a saturating gas. When the pressure vessel is sealed, the material is exposed to a high pressure saturating gas. The high pressure gas will then start to diffuse into the thermoplastic polymer over time, filing the thermoplastic polymer's free intermolecular volume. The gas will continue to saturate the thermoplastic polymer until equilibrium is reached. Depending on the length of time the parison is treated with the saturating gas, the parison may be fully saturated with the saturating gas. Alternatively, the parison may be partially saturated with the saturating gas. Depending on the size and thickness of the walls of the parison, and the pressure of the saturating gas, the duration of treatment of the parison with high pressure saturating gas may vary from about 2 hours to about 60 days. In one embodiment, the treatment lasts from about 15 days to about 25 days. In another embodiment, the treatment lasts for about 21 days. The amount of time for complete saturation can be determined beforehand. For example, a test using the polymer parison to be blow molded can be conducted at various temperature and pressure conditions and sampled at various time intervals. The sample can be pulled from the pressure vessel and measured for weight. When the weight of the sample ceases to increase over time, the sample has reached complete saturation for the given temperature and pressure. The time can be noted, and various tables for achieving complete saturation can be created for any given combination of temperature and pressure conditions for any thermoplastic material.

During treating in block 110, a plurality of solid parisons may be treated simultaneously at an elevated pressure to provide a plurality of gas-saturated parisons. The disclosure herein provides methods and apparatus for saturating a plurality of parisons continuously or in batches so as to enable an efficient process.

From block 110, the method may alternatively proceed to block 115, desorption. Because the gas-saturated parison is moved to an environment of lower pressure, the thermoplastic material of the gas-saturated parison becomes thermodynamically unstable, which means that the thermoplastic material is no longer at equilibrium with the surrounding environment and that the thermoplastic material becomes supersaturated with the saturating gas. The gas-saturated parison will start to desorb gas from its surface into the surrounding environment. In some embodiments, after treating with the saturating gas and before heating, the parisons are allowed to partially desorb gas. The desorption of some of the gas, in some circumstances, helps to avoid creation of the cellular structure in certain areas of the parison, such as at the surface. Desorption can occur when the high-pressure saturating gas is vented from the pressure vessel or when the gas-treated parison is removed into ambient atmosphere pressure.

From block 110 (skipping block 115), or alternatively from block 115, the method can proceed to block 120, heating. In block 120, the gas-saturated solid parison is heated to produce a cellular parison. The parison or parisons may be heated with any heating methods and apparatuses including, but not limited to, infrared heating and air impingement oven. Heating of the gas-treated parison in block 120 may be carried out at a temperature below the melting temperature of the thermoplastic material. The heating produces a cellular and solid parison. Since the parison is still in a solid state, the foam that is produced is distinguishable from foaming that is produced from an extruder upon extruding a polymer melt.

The cellular solid parison may have uniform wall thickness with nucleated bubbles formed within the parison wall. The heating temperature will depend on the type of thermoplastic materials. For example, the heating temperature may be from about 50° C. to about 175° C. for a parison made from polyethylene terephthalate; the heating temperature may be from about 50° C. to about 150° C. for a parison made from polyvinyl chloride; the heating temperature may be from about 40° C. to about 1250 for a parison made from poly(lactic acid); the heating temperature may be from about 50° C. to about 125° C. for a parison made from acrylonitrile butadiene styrene; the heating temperature may be from about 50° C. to about 150° C. for a parison made from polystyrene, the heating temperature may be from about 50° C. to about 150° C. for a parison made from polycarbonate, the heating temperature may be from about 100° C. to about 200° C. for a parison made from polypropylene, and the heating temperature may be from about 75° C. to about 150V for a parison made from polyethylene. In one embodiment, the heating temperature is about nor for a parison made from polyethylene terephthalate.

From block 120, the method proceeds to block 125. In block 125, the cellular parison is blow molded. Blow molding is a step in which the cellular parison is placed in a mold and further heated to a temperature above the melting or softening point of the parison, and then the parison is stretched with a molding gas into the shape of the mold to provide the finished thermoplastic cellular article. The blow molding step 125 may alternatively include mechanical stretching 118 of the parison, such as with a plunger discussed above. A person skilled in the art would readily appreciate that any inert gas could be useful as a molding gas. In one embodiment, the molding gas is compressed air. Additionally, other molding gases useful for expanding the cellular parison include, but are not limited to, nitrogen, argon, xenon, krypton, helium, carbon dioxide, or any combination thereof. The parison or parisons may also be heated in block 125 by applying heat to the mold. The parison heating that takes place during the blow molding step 125 may cause further formation of nucleated bubbles, i.e., foaming, in the thermoplastic material of the parison. The foaming continues during the blow molding process, resulting in a cellular thermoplastic article 140 as the finished product after a cooling period, block 130.

In some embodiments, after blow molding, block 125, the mold can be heated to cause crystallization of the polymer material in an optional step, block 128. In some embodiments, the blow mold could be provided with heating elements. In block 128, the polymer material may be heated in the blow mold to within the range of about 250° F. to 380° F. to cause crystallization of the polymer. After heating/crystallization block 128, the blow molded article can be moved to another cooled blow mold to set the final shape of the article. The optional step of heating/crystallization can be used for materials with low heat deflection temperatures, such as semi-crystalline polyethylene terephthalate and poly(lactic acid). The step of heating/crystallization can be used to produce heat resistant articles that are capable of being hot filled, such as with hot liquids, or reheated in microwave ovens.

Disclosed are embodiments for saturating solidified parisons with a saturating gas prior to re-heating in preparation for solid state foaming and blow molding. The processes for saturating parisons can be continuous or in batches. The processes for saturating parisons may saturate a plurality of parisons in an expedient and economical manner, which is advantageous.

Referring to FIG. 3, a diagrammatical illustration of a process for continuously saturating parisons with a saturating gas, is illustrated. The process for saturating solid and noncellular preformed parisons 206 begins by obtaining the solid and noncellular parisons, block 202. A representative parison 206 (best seen in FIG. 4) has a hollow body with a closed rounded end and an open neck 274 at the opposite end. The neck 274 can be of a larger diameter than the remainder of the body. In some embodiments, parisons 206 may have a ridge 258 provided on the neck 274. In some embodiments, the parisons 206 can have one or more ridges 258 which function as threads in the finished article. In some embodiments, the parisons can have a straight wall on all sides, such as parison 406 illustrated in FIGS. 20-23. Similar to parison 206, parison 406 has a closed end and an open end. However, parison 406 may omit a larger diameter neck portion and an even larger diameter ridge. In general, parisons of any shape may be saturated using the methods disclosed herein. While a representative parison is used in describing the various embodiments, the particular parison should not be construed as limiting. In the embodiment of FIG. 3, a plurality of parisons, such as parisons 206 or 406, are saturated with the saturating gas while being transferred through a sealed and pressurized tube 204. The tube 204 terminates at or in proximity to the blow molding equipment, block 206, where the gas-saturated solid parisons may be unloaded from the tube 204 and deposited into the blow molding equipment 206 for re-heating the gas-saturated parisons to create the solid state foamed parisons. The tube 204 can be pressurized with a saturating gas as described herein. For example, the tube 204 can be connected to a supply of saturating gas for constant regulation of the gas pressure within the tube 204. In some embodiments, the tube 204 is maintained at constant or near constant pressure using 100% carbon dioxide. The tube 204 is sealed at both the entrance and exit to the tube 204. The parisons 206 may be loaded and unloaded using pressure lock devices generally described herein. The parisons 206 can reside in the tube 204 for a period of time so that the parisons become fully saturated with the saturating gas. The time and pressure for saturation may be adjusted based on various factors, such as the material in question, the temperature at which saturation occurs, and the length of the treatment tube 204. For any given material, lower pressure can require greater time, while higher pressure can require less time for saturation. Once the time needed to saturate any parison of a given material is determined, the length of the tube 204 can be set.

In some embodiments, the tube 204 can be the single-walled tube 201 illustrated in FIG. 4. In a single-walled tube 201, the parisons 206 are placed end to end within the tube 204, such that the closed end of the parison fits within the larger diameter neck portion 274 of an adjacent parison 206. However, in FIG. 20, straight walled parisons 406 can be used as well. In FIG. 20, the parisons 406 can be aligned with a closed end of one parison 406 next to an open end of an adjacent parison 406. However, the parisons 406 can be arranged so that similar ends are next to one another. That is, a closed end of parison 406 can be next to a closed end of an adjacent parison 406, or an open end of a parison 406 can be next to an open end to an adjacent parison 406.

The tube 201 in FIGS. 4 and 20 can have a diameter that is only slightly larger than the largest diameter of the parisons 206, 406. The parisons 206, 406 are transferred through the tube 204 via gravity or by mechanically pushing on the parison that is the last one loaded in the tube 204, which then causes all other parisons 206, 406 in the tube 204 to advance. In a single-walled tube 204, the saturating gas is injected into the tube 204, and the gas pressure within the tube interior 208 is maintained as the parisons 206, 406 are transferred within the tube 204. In some embodiments, the solid parisons 206, 406 may be loaded within the tube 204 via a pressure lock device and removed at the end of the tube 204 via a second pressure lock device. A description of a general pressure device lock is described below.

In some embodiments, the double-walled tube 203 of FIG. 5 and FIG. 21 may be used as the tube 204 of FIG. 3. A double-walled tube 203 includes an inner tube 212 within the outer tube 203. The inner tube 212 may be perforated with holes 214 to allow the transfer of the saturating gas from the annular space 216 between the outer tube 204 and the inner tube 212. The inner tube 212 can have a diameter that is only slightly larger than the largest diameter of the parisons 206. The inner tube 212 holds the parisons 206, 406 in the end to end manner described above for the respective parisons 206 or 406. The outer tube 204 serves to maintain the gas pressure of the saturating gas. As in the single-walled tube 201, the loading and unloading of parisons from the double-walled tube 204, and specifically from the inner tube 212, can be performed via the use of a pressure lock device at both the entrance and exit to the double-walled tube 203.

In some embodiments, multiple perforated tubes 218 connected in bundles, and placed within an outer tube 219 as illustrated in FIG. 6 can be used as the tube 204 of FIG. 3. The concept is similar to the concept illustrated in FIG. 5; however, a multiplicity of perforated inner tubes 218 are bundled together within the inside of the larger tube 219. The plurality of inner tubes 218 are connected to each other via bands 222 at various locations.

Referring to FIG. 7, pressure locks 224, 226 are diagrammatically illustrated at the entrance and exit of the tube 204. The entrance pressure lock 224 may include a rotating cylinder 230 with a multiplicity of chambers 232 for placing parisons 206 or 406 therein. While FIG. 7 is illustrated with a parison 206 having a neck portion 274 and ridge 258, it should be appreciated that pressure locks may be used with the parison 406, or any other type of parison. The parisons 206 or 406 may drop by gravity into the empty chambers one at a time via a loading machine (not illustrated), or, alternatively, a robotic device (not illustrated) can place each parison 206 or 406 within an empty chamber 232. After a parison 206 or 406 is loaded into a chamber 232, the cylinder 230 may rotate to align the chamber 232 with parison 206 or 406 therein directly over the entrance of the various embodiments for the tube 204. As the cylinder 230 rotates, a different chamber becomes aligned with the entrance to the tube 204. The chamber that becomes aligned with the tube 204 is sealed from the exterior by including a series of seals 234 to prevent or to at least minimize the escape of saturating gas from the pressurized tube 204. A structural frame 228 can include the seals 234, 235 on both the top and bottom of the chamber that becomes aligned with the tube 204 entrance. The seals 234, 235 may be “O” rings, for example. The cylinder 230 may include a plurality of chambers 232 to allow the placement of a parison 206 or 406 in an empty chamber 232 while a chamber 232 that is aligned with the tube 204 deposits a parison 206 or 406 into the tube 204. The parison 206 or 406 that is deposited in the tube 204 may fall under the force of gravity, or, alternatively, a piston (not shown) may be provided in direct alignment above the chamber to push the parison 206 or 406 into the pressurized tube 204. The pressure lock 224 at the entrance of tube 204 may operate in conjunction with a pressure lock 226 at the exit of the tube 226. As one gas-unsaturated parison enters the pressurized tube 204, a second gas-saturated parison 207 may be removed from the end of the pressurized tube 204 via a similar pressure lock 226 that is located at the exit of the tube 204. Similar to the entrance pressure lock 224, the exit pressure lock 226 may have a revolving cylinder 238 with a plurality of chambers 240. The parisons 207 may drop via gravity into an empty chamber 240, after which the cylinder 238 is caused to rotate to a position that allows the parisons 207 to be removed from their respective chambers 240. The pressure lock 226 can include an upper and lower seal 242, 243 that seals the chamber 240 that is open to the tube 204 to minimize or reduce the escape of the saturating gas from the tube 204. The gas-saturated parisons 207 may be removed from the pressure lock 238 via a robotic device. Alternatively, the gas-saturated parisons 207 may drop by gravity into a collection bin and thereafter become sorted and aligned to pass on to the re-heating station before blow molding. The gas-saturated parisons 207 removed from the pressure lock 226 at the end of the pressurized tube 204 are re-heated and blow molded as described above.

In accordance with FIGS. 3-7, 20, and 21 methods for saturating parisons with a saturating gas sufficient to foam when heated may include the following steps: placing gas-unsaturated parisons 206, 406 at one end of an elongated tube 204, wherein the parisons 206, 406 are arranged longitudinally end to end within the tube 204; pressurizing the tube with a saturating gas; transferring the parisons 206, 406 within the tube 204 with the saturating gas for a period of time sufficient to saturate the parisons 206, 406 with the gas; and removing gas-saturated parisons 207, 406 at an opposite end of the tube 204 after having been transferred through the tube. In some embodiments, the gas is substantially 100% by weight carbon dioxide. In some embodiments, the parisons 206, 406 are substantially 100% polyethylene terephthalate. In some embodiments, the tube 204 includes at least one inner perforated tube 212, 218, within an outer tube 203, 219 wherein the parisons 206, 406 are transferred in the inner tube 212, 218. In some embodiments, the parisons 206, 406 are fully saturated with the saturating gas after exiting the tube 204, and in other embodiments, the parisons 206, 406 are partially saturated with the saturating gas after exiting the tube 204.

Referring to FIGS. 8-11, another embodiment of a system for saturating gas-unsaturated parisons 206 is illustrated. In this embodiment, parisons 206 are stacked in multiple levels. The parisons 206 are arranged such that the longitudinal axes of the parisons 206 are generally vertical. Furthermore, the parisons 206 of one level in the stack are aligned with the parisons 206 of an adjacent level. This allows the parisons 206 at one level to partially nest within the parisons 206 of the adjacent level. However, FIG. 22 shows an embodiment of stacking straight walled parisons 406.

A vertical stack as shown in FIG. 8 allows the placement of a large number of parisons 206 or 406 at a time within a pressure vessel. In this embodiment, the pressure vessel can be any of a number of configurations that is sized to hold a stack of the parisons 206.

In some embodiments, parisons 206 are stacked vertically with the use of a stacking rack 249 illustrated in FIG. 9, and a plurality of modular loading trays 250, illustrated in FIG. 10. The loading trays 250 can all be similar in design, which allows interchangeability and simplicity. The stacking rack 249 includes a round base 248 that can have two or more upright alignment arms 244. A round design is only representative, as the base and trays can be other shapes. In the case of two alignment arms 244, the arms 244 may be placed opposite to each other. In cases of more than two alignment arms 244, the arms 244 may spaced equidistant from each other around the periphery of the base 248. The arms 244 may include grasping means, such as holes 246. The grasping means allow lifting the assembly into a pressure vessel.

The parisons 206 are loaded on and supported on the loading tray 250 illustrated in FIG. 10. The loading tray 250 includes a rounded plate having an equal number of slots 252 as the bottom tray has arms 244, such that the slots 252 are positioned along the periphery of the plate at corresponding locations to the arms 244. The slots 252 retain the tray 250 on the stacking rack 249, and also allow the trays 250 to stack in a predetermined orientation, such that the parisons 206 on the trays will become aligned with each other. The loading tray 250 has two or more support legs 254 projecting down from the lower surface of the tray 250. The support legs 254 provide separation from the adjacent loading trays and bear the weight of the loading tray 250 and the trays resting above to avoid placing weight on the parisons 206. The loading tray 250 has holes 256 for the placement of the gas-unsaturated parisons 206. The holes 256 can be sized larger the body of a parison 206, but smaller than the necks 274. The parisons 206 can be supported within the holes 256 by either being supported by the ridge 258 on the neck 274, or by step between the narrow diameter body and the larger diameter neck 274.

In a vertically stacked arrangement of parisons 206, gravity forces the parisons 206 such that their longitudinal axis become aligned in the vertical direction, unlike a horizontal arrangement that requires supporting the parisons at both ends.

The individual parisons 206 may be stacked into the loading trays 250 via a robot. Once a loading tray 250 has been filled with parisons 206, the fully loaded tray 250 is placed on the base 248 with the arms 244 receiving the slots 252. Additional loading trays 250 may be filled and stacked one atop the other in a similar manner. The cooperation of the arms 244 and slots 252 provide that the parisons 206 of one tray become aligned with the parisons 206 of an adjacent tray 250. The support legs 254 on the trays 250 maintain a separation distance between trays 205, such that the closed end of one level of parisons can nest within the open end (necks) of parisons 206 from an adjacent level, but the separation distance is predetermined to avoid the closed end of the parisons 206 from touching or resting on the necks 274. Generally, areas of parisons that are to be saturated with gas should avoid or minimize contact with structure or other parisons.

As illustrated in FIG. 11, a close-up view shows a parison 206 within the loading tray 250 being supported by the ridge 258, while the adjacent closed end of a second parison 206 is nested within the neck 274, but does not touch the neck 274.

As illustrated in FIG. 8, a series of five loading trays 250 may be stacked on the base 248. It is to be appreciated that fewer or more numbers of loading trays may be stacked.

FIG. 20 is a diagrammatical illustration showing how straight walled parisons 406 may be stacked vertically. Because the straight walled parisons 406 have no neck portions that may be used to support the parisons 406 on the trays 250, the trays 205 can be offset or rotated so that the holes of one tray 250 align with a solid section of a tray 250 beneath it in order to support the parisons 406. Stacking may be done by the following process. An empty tray 250 may be placed on the base 248, and then the empty tray 250 is loaded with parisons 406. A second empty tray 250 is placed over the first tray 250, such that the holes of the tray 250 on top become aligned with solid sections of the tray 250 on bottom, and then the tray 250 on top is loaded with parisons 406. Alternatively, the trays 250 can be stacked so that the holes of adjacent trays are in alignment. In this case, the first tray 250 is placed on the base 248, and the tray 250 is loaded. The support legs 254 can be long enough such that the top end of the parisons 406 fit within the holes 256 but end below the top surface of the tray 250. Then a subsequent tray 250 is placed over the first tray, such that the holes of the subsequent tray 250 are aligned with the holes of the first tray. Then, the subsequent tray 250 is loaded with parisons 406, such that the parisons 406 may come to rest on the lower parisons 406, or the holes 256 of the lower tray. For straight walled parisons 406, the parisons 406 may be stacked with either the closed end or the open end being supported by the holes 256 in the tray 250. Furthermore, if the parisons 406 are aligned end to end with each other, the parisons may be aligned with a closed end adjacent to a closed end of another parison, or an open end adjacent to an open end of an adjacent parisons. In any case, straight walled parisons 406 can be vertically stacked with a single tray that holds either the open end or the closed end of the parisons 406 aligned in the stack.

In the embodiment of FIGS. 8-11, and 20, the trays are modular, and similar to each other. Therefore, trays 250 are replaceable and interchangeable. The parisons 206 or 406 could be loaded from a conveyor by an automated arm or by dropping into the trays 250, as the trays 250 pass on a conveyor. The unloading process could use a similar arm or the trays 250 could be dumped onto a conveyor. The parisons 206 or 406 are held on the trays 250 by gravity and the alignment slots 252 in the trays 250 ensure parisons become aligned and prevent rotation. The trays 250 and the stacking rack 249 can have attachment points to allow machinery to pick up the trays 250 and stacking rack 249 for loading and unloading of the pressure vessel. In some embodiments, all the trays 250 are stacked on the stacking rack 249 before being placed in the pressure vessel. However, in some embodiments, the trays 250 can be loaded one by one in the pressure vessel, and the stack is created within the pressure vessel.

In accordance with FIGS. 8-11, and 20 methods for saturating parisons with a saturating gas sufficient to foam when heated may include the following steps: stacking trays 250 containing vertically aligned parisons 206, 406 on a rack, wherein each parison 206, 406 has a body with two ends, such as a closed end and an opposite open end of the body, and wherein the parisons 206, 406 are supported by either the open end or the closed end in holes 256 in the trays 250; placing the parisons 206, 406 assembled on the trays 250 in a pressure vessel, wherein the longitudinal axes of the parisons 206, 406 are substantially vertical; pressurizing the pressure vessel with a saturating gas; and saturating the parisons 206, 406 with gas sufficient to create cells in the parisons 206 when heated. In some embodiments, the parisons 206 comprise a neck 274 connected to the open end, and the parisons 206 are supported by their neck 274 in the holes 268 in the trays 262, wherein the closed end of a parison 206 nests within an open neck 274 of an adjacent lower parison 206. In some embodiments, each tray 250 is similar and comprises a plurality of holes 256 larger than a size of the parison body and smaller than a size of the neck 274, and legs 254 extending vertically to support one tray on top of another. In some embodiments, each tray 250 includes one or more holes 252 matching a size of a vertically placed alignment arm 244 extending upright from a base 248. In some embodiments, the parisons 206, 406 are substantially 100% polyethylene terephthalate. In some embodiments, the saturating gas is substantially 100% carbon dioxide. In some embodiments, the closed end of one parison 206 does not touch the inside of the neck 247 of an adjacent parison 206 when nested. In some embodiments, the neck 247 includes a ridge 258 that supports the parison 206 from the tray 250. While the method describes a parison with a closed and open end, it is possible that the methods are used with parisons with two open ends or two closed ends.

Referring to FIGS. 12-15, and 23 another embodiment of a system for saturating gas-unsaturated parisons 206 or 406 is illustrated. In the embodiment of FIGS. 12-15, and 23, the parisons 206 or 406 are stacked using a sets of two different types of trays. In this embodiment, rather than placing the stack so that the longitudinal axes of the parisons 206 or 406 are vertical, the stack is placed in the pressure vessel so that the longitudinal axes of the parisons are horizontal.

Each set of trays includes a loading tray 270 and a lid tray 262. The purpose of having two types of trays is to support the parisons at both ends, so that the parisons can be horizontal. The lid tray 262, illustrated in FIG. 14, can hold the closed end of the parisons 206, while the loading tray 270 illustrated in FIG. 13 holds the necks 274 of the parisons 206. The stack, illustrated in FIG. 12, can have a lid tray 262 at both ends.

Referring to FIG. 14, the lid tray 262 includes a generally round plate that includes a plurality of holes 268 whose diameters are sized slightly larger than the closed end of the parisons 206 to allow the closed end of the parisons 206 to fit therein, but not so large that the parisons 206 can become misaligned or move. The purpose is to generally hold the parisons 206 straight with respect to the immediately adjacent parisons in the adjacent layers to allow nesting of one parison within the adjacent parison. As shown in FIG. 14, the lid tray 262 tray includes a rim 263 extending from one side and perpendicular to plate around the circumference of the lid tray 262. The lid tray 262 also includes a lip 269 around the circumference of the flat plate.

FIG. 13 shows a loading tray 270 resting on a lid tray 262. The loading tray 270 can include a round flat plate having a plurality of holes 272 therein. The holes 272 are sized larger than the holes 268 of the lid tray 262. The holes 272 can allow the larger diameter neck 274 of the parisons to fit therein and be supported by the ridge 258 on the neck 274, for example. Alternatively, the holes 272 are larger than the diameter of the parison body, but smaller than the neck 274, so that the parisons 206 are supported by the step between the body and the neck 274. The loading tray 270 can include a plurality of support legs 264 extending on one side of the tray 270 to act as separators between the loading tray 270 and the lid tray 262. The legs 264 are placed around the periphery of the loading tray 270 and are spaced equidistant from one another. Any number of support legs 264 can be used. The lip 269 of the lid tray 262 has a circumference that is smaller than the circumference that is described by the support legs 264 on the supporting tray 270. In this manner, the lid tray 262 can receive the support legs 264 on the rim 269, which aligns the loading tray 270 with the lid tray 262. To prevent any rotational movement among trays, and so that the loading tray 270 becomes aligned to the lid tray 262, the lid tray 262 may include keys or notches such that the support legs 264 on the loading tray 270 can fit therein so as to prevent rotation relative to each other.

As shown in FIG. 15, the rim 263 extends from the lid tray 262, and the rim 263 has an inner diameter that matches the outer diameter of the loading tray 270, such that the rim 263 can fit on the loading tray 270. The rim 263 can have a lip that prevents the rim 263 from coming to rest on the parisons 206. However, in some embodiments, the lid tray 262 can come to rest on the necks of the parisons 206. The lid tray 262 can align the closed end of a parison 206 within the interior of a neck 274 of an adjacent parison 206. Additionally, the closed end of a parison 206 supported by the lid tray 262 can nest within the open neck 274 of the adjacent parison supported by the loading tray 270, as shown in FIG. 15. Furthermore, the support legs 264 can be sized so as to attain a separation distance between the closed end of a parison 206 from touching the inside of the neck 274 of an adjacent parison 206. Because the lid tray holes 268 are sized to match the diameter of the body portion closely, the parisons 206 can be held in a horizontal position without much movement thereby avoiding the closed end of the parison 206 from touching the neck 274 of the adjacent parison.

FIG. 23 is a diagrammatical illustration showing how straight walled parisons 406 may be stacked horizontally. Because the straight walled parisons 406 have no neck portions that may be used to nest one inside the other, the set of lid trays 262 and loading trays 270 used to support parisons 406 from the closed end and the open end may be used in the following manner. A bottom loading tray 270 is assembled together with the lid tray 262 by placing the lid tray 262 on top of the loading tray 270, such that the holes of the lid tray 262 align with the holes of the loading tray 270. Then, the parisons 406 may be loaded such that the loading tray 270 holes hold the closed end of parisons and the lid tray 262 holes hold the open ends of parisons 406. With straight walled parisons, the holes of the loading tray 270 may be the same size as the holes of the lid tray 262. In some embodiments, the loading tray 270 holes hold the open end of parisons 406 and the lid tray 262 holes hold the closed end of parisons 406. A subsequent set including a loading tray 270 and lid tray 262 are assembled and loaded in the manner just described. The subsequent set of lid tray 262 and loading tray 270 is then juxtaposed next to the previous set. In some embodiments, the sets are assembled such that the longitudinal axes of parisons 406 are offset from the longitudinal axes of the parisons 406 of an adjacent level, as illustrated. However, in other embodiments, the longitudinal axes of adjacent parisons 406 may be aligned with each other, such that it is possible that the open end of one parison may support the closed end of an adjacent parison. Also, the parisons may be inverted, such that when parisons are longitudinally aligned, the closed end of one parison rests on the closed end of an adjacent parison, and the open end of one parison rests on the open end of an aligned parison. As shown, the holes in one set of lid tray 262 and loading tray 270 are not in alignment with the holes in the adjacent set of lid tray 262 and loading tray 270. However, in horizontal stacking of parisons 406, the two trays are used to support parisons 406 from both ends, similar to the embodiment illustrated in FIG. 15.

The configuration achieved by using sets of two different trays, including a loading tray 270 and a lid tray 262 to hold and align parisons at both ends, as just described, allows the placement of the sets of trays holding parisons into a pressure vessel in the horizontal configuration. By horizontal is meant a configuration in which the longitudinal axes of the parisons is generally horizontal. The pressure vessel diameter may be closely matched to the exterior diameter of the loading tray 270 and lid tray 262. In FIG. 12, it can be seen that five sets of lid trays and supporting trays can be arranged in a horizontal stack. However, it is to be appreciated that the stack can be built with fewer or more sets of trays.

In the embodiment of FIGS. 12-15, and 23, the trays are modular, and use two types of trays. Therefore, the trays can be replaceable and interchangeable. The parisons 206 could be loaded on the loading trays 270 from a conveyor by an automated arm or by dropping into the trays, as the trays pass on a conveyor. The unloading process could use a similar arm or the trays could be dumped from the trays onto a conveyor. The trays hold the parisons in alignment holes in the trays. The trays can have attachment points to allow machinery to pick up the trays for loading and unloading of the pressure vessel. In some embodiments, all the trays are stacked before being placed in the pressure vessel. However, in some embodiments, the trays can be loaded one by one in the pressure vessel, and the horizontal stack is created within the pressure vessel.

In accordance with FIGS. 12-15, and 23, methods for saturating parisons 206, 406 with a saturating gas sufficient to foam when heated may include the following steps: stacking trays containing horizontally aligned parisons 206, 406 wherein each parison 206, 406 has a body with two, opposite ends, and each parison 206, 406 is supported by both ends with a first perforated loading tray 270 at one end and a second perforated lid tray 262 at the other end, placing the parisons 206 assembled on the trays 270, 262 in a pressure vessel, wherein the longitudinal axes of the parisons 206, 406 are substantially horizontal; pressurizing the pressure vessel with a saturating gas; and saturating the parisons 206, 406 with a saturating gas sufficient to create cells in the parisons 206, 406 when heated. In some embodiments, the parisons 206 have a neck 274 connected to the open end of the body, and wherein the first loading tray 270 supports the necks 274 of parisons 206 and the second lid tray 262 supports the closed ends of parisons 206, and wherein the closed end of a parison 206 nests within an open neck 274 of an adjacent parison 206. In some embodiments, the first perforated loading tray 270 has holes 272 larger than the holes 268 of the second perforated lid tray 262. In some embodiments, the first perforated loading tray 270 comprises support legs 264 to rest on an adjacent perforated lid tray 262, and the lid tray 262 comprises a rim 263 around the periphery that extends perpendicular to the lid tray 262, wherein the rim 263 fits on the periphery of an adjacent first loading tray 262. In some embodiments, the parisons 206, 406 are substantially 100% polyethylene terephthalate. In some embodiments, the saturating gas is substantially 100% carbon dioxide. In some embodiments, the closed end of one parison 206 does not touch the inside of the neck 274 of an adjacent parison 206 when nested. While the method describes a parison with a closed and open end, it is possible that the methods are used with parisons with two open ends or two closed ends.

Referring to FIG. 16, another embodiment of a system for saturating gas-unsaturated parisons 206 or 406 is illustrated. While the illustration show a parison 206 with a larger diameter neck, it is to be appreciated that the straight walled parisons 406 may be used as well, or any other shape of parison. In this embodiment, the individual parisons 206, 406 are each placed into individual, separate and distinct pressure vessels 278 capable of supporting a single parison 206, 406. Gas-unsaturated parisons 206, 406 are obtained in block 202. The process includes placing a single parison 206 or 406 within a single pressure vessel 278. The process includes pressurizing the individual pressure vessels 278 with a saturating gas, and then re-pressurizing the individual pressure vessels 278 at predetermined intervals, because the gas will be absorbed by the parison 206, 406 in the pressure vessel 278, and lower the pressure. The pressure vessels 278 may be conveyed past a plurality of pressurizing stations 280. The pressure vessels 278 can be transferred on a conveyor for a period of time sufficient to provide a concentration of gas in the parisons 206, 406 that will lead to the creation of cells when the gas-saturated parisons 206, 406 are heated.

Illustrated in FIGS. 17-19 are representative embodiments of individual pressure vessels suited to receive an individual parison 206 or 406. In some embodiments, the individual pressure vessel includes a container portion and a lid portion. In some embodiments, the lids may be separable from the container, whereas in other embodiments, the lids may be directly attached to the container body.

Illustrated in FIG. 17 is a pressure vessel 283 that may be used as the pressure vessel 278 of FIG. 16. The pressure vessel 283 may include a removable lid 286. The pressure vessel body 282 includes a supporting tray 284 placed within the interior of the body 282. The tray 284 may include a single hole sized to hold a single parison 206, 406 therein. For example, the tray 284 may include a hole sized to match the body diameter of the parison 206, but the hole is smaller than the neck 274. In this manner, the parison 206 is held within the pressure vessel 283 via the step between the relative small diameter of the body and the larger diameter of the neck 274. In the case of the straight walled parison 406, the parison 406 may come to rest on the floor of the pressure vessel. The pressure vessel 283 is suited to withstand the pressures described above. In order to secure the lid 286 to the body 282, the lid 286 may include angled barbs 292 that grip the side of the body 282 and secure the lid 286 to the body 282. The lid 286 can be removed, for example, by using a disengaging device in the form of a sleeve that is inserted between the lid 286 and the container body 282. The sleeve pushes the angled barbs 292 inward so as to permit release of the lid 286 from the container body 282.

The lid 286 is sealed to the upper end of the container body 282 via a sealing member 290, such as a gasket to avoid or minimize leakage of the saturating gas. The lid 286 or the container body 282 may include a gas injection port 288. The gas injection port 288 is a one-way valve that prevents gas from escaping the pressure vessel 278. For example, the one-way valve may include a spring-loaded plug that presses against a seat, thus sealing the interior of the pressure vessel 278.

Illustrated in FIG. 18 is a pressure vessel 295 that may be used as the pressure vessel 278 of FIG. 16. The pressure vessel 295 has a lid 298 attached to the container body 294 via a spring-loaded hinge 306. In this embodiment, the angled barb 304 may be placed opposite to the spring-loaded hinge 306. A similar tubular sleeve may be used to disengage the lid 298 by pressing the barb inward to release the lid 298 from the container 294.

The pressure vessel body 294 includes a supporting tray 296 placed within the interior of the body 294. The tray 296 may include a single hole sized to hold a single parison 206, 406 therein. For example, the tray 296 may include a hole sized to match the body diameter of the parison 206, but is smaller than the neck 274. In this manner, the parison 206 is held within the pressure vessel 294 via the step between the relative smaller diameter of the body and the larger diameter of the neck 274. In the case of the straight walled parison 406, the parison 406 may come to rest on the floor of the pressure vessel. The pressure vessel 278 is suited to withstand the pressures described above.

The lid 298 is sealed to the upper end of the container body 294 via a sealing member 302, such as a gasket to avoid or minimize leakage of the saturating gas. The lid 298 or the container body 294 may include a gas injection port 300. The gas injection port 300 is a one-way valve that prevents gas from escaping the pressure vessel 278. For example, the one-way valve may include a spring-loaded plug that presses against a seat, thus sealing the interior of the pressure vessel 278.

Illustrated in FIG. 19 is a pressure vessel 307 that may be used as the pressure vessel 278 of FIG. 16. The individual pressure vessel 307 may include a threaded lid 312 that is threaded onto the open end of the pressure vessel body 308.

The pressure vessel body 308 includes a supporting tray 310 placed within the interior of the body 308. The tray 310 may include a single hole sized to hold a single parison 206, 406 therein. For example, the tray 310 may include a hole sized to match the body diameter of the parison 206, but is smaller than the neck 274. In this manner, the parison 206 is held within the pressure vessel 307 via the step between the relative smaller diameter of the body and the larger diameter of the neck 274. In the case of the straight walled parison 406, the parison 406 may come to rest on the floor of the pressure vessel. The pressure vessel 278 is suited to withstand the pressures described above.

The lid 312 is sealed to the upper end of the container body 308 via a sealing member 316, such as a gasket to avoid or minimize leakage of the saturating gas. The lid 312 or the container body 308 may include a gas injection port 314. The gas injection port 314 is a one-way valve that prevents gas from escaping the pressure vessel 307. For example, the one-way valve may include a spring-loaded plug that presses against a seat, thus sealing the interior of the pressure vessel 307.

The loading of the various embodiments of the individual pressure vessels 278, 283, 295, and 307 may be accomplished using a plurality of robotic devices that open each individual pressure vessel. In the case where the lid may be separable from the pressure vessel, one robotic device may provide the pressure vessel container while a second robotic device may provide the corresponding lid. Both the container and the lid may travel on conveyors. Because the pressure vessels 278, 283, 295, and 307 can be reused, the pressure vessels are returned from the area where the pressure vessels are unloaded in proximity to the blow molding device. The parisons 206, 406 may be loaded within the individual pressure vessels 278, 283, 295, and 307 via a robotic device which picks and places each individual parison into an individual pressure vessel. Once the pressure vessel is loaded with a parison, the lid is placed on the pressure vessel. In some embodiments, the lid may be compressed onto the open end of the pressure vessel via a plunger. In other cases, the lid may be threaded onto the open end of the pressure vessel. Once the pressure vessel is loaded with a parison and sealed in an airtight manner, the individual pressure vessel is pressurized with the saturating gas. Once pressurized, a plurality of pressure vessels 278, 283, 295, and 307 can travel along the conveyor 276. Periodically, the pressure vessels 278, 283, 295, and 207 may be repressurized due to the absorption of the saturating gas into the parison. For example, a conveyor may be equipped to pressurize each individual pressure vessel at 15-minute intervals. Experiments may be performed to determine the amount of time required and pressure in order to suitably saturate parisons with the saturating gas to a gas concentration sufficient to create cells in the parison when heated. The conveyor may be of a length sufficient to provide the necessary time needed to complete saturation to an acceptable level.

When the individual pressure vessels reach the blow molding apparatus, robotic devices may first depressurize each individual pressure vessel 278, 283, 295, and 307, open or otherwise remove the lid from the pressure vessel, extract the gas-saturated parison from the individual pressure vessel and transport it to the heating ovens for blow molding.

In accordance with FIGS. 16-19, methods for saturating parisons with a saturating gas sufficient to foam when heated may include the following steps: placing a gas-unsaturated parison 206, 406 in a pressure vessel 278, 283, 295, or 307, individually; pressurizing the pressure vessel 278, 283, 295, or 307 with the parison 206, 406 with a saturating gas; periodically re-pressurizing the pressure vessel 278, 283, 295, or 307 as the parison 206, 406 absorbs the gas; transferring the pressure vessel 278, 283, 295, or 307 with the parison 206, 406 for a period sufficient to achieve a concentration of gas sufficient to create cells in the parison 206, 406 when heated; and removing the gas-saturated parison 206, 406 from the pressure vessel 278, 283, 295, or 307. In some embodiments, the parison 206, 406 is substantially 100% polyethylene terephthalate. In some embodiments, the saturating gas is substantially 100% carbon dioxide. In some embodiments, the parison 206 comprises an elongated body portion closed at one end, and a neck 274 portion of a larger diameter connected to an open end of the body portion.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for saturating parisons with a saturating gas sufficient to foam when heated, comprising:
placing gas-unsaturated parisons at one end of a tube, wherein the parisons are arranged longitudinally end to end within the tube;
pressurizing the tube with a saturating gas;
transferring the parisons within the tube with the saturating gas for a period of time sufficient to saturate the parisons with the gas; and
removing gas-saturated parisons at an opposite end of the tube.

2. The method of claim 1, wherein the gas is substantially 100% carbon dioxide.

3. The method of claim 1, wherein the parisons are substantially 100% polyethylene terephthalate.

4. The method of claim 1, wherein the tube comprises at least one inner perforated tube within an outer tube, wherein the parisons are transferred in the inner tube.

5. A method of saturating parisons with a saturating gas sufficient to foam when heated, comprising:
stacking trays containing vertically aligned parisons on a rack, wherein each parison has a body with two ends, and wherein the parisons are supported by either end in holes in the trays;
placing the parisons assembled on the trays in a pressure vessel, wherein the longitudinal axes of the parisons are substantially vertical;
pressurizing the pressure vessel with a saturating gas; and
saturating the parisons with the gas sufficient to create cells in the parisons when heated.

6. The method of claim 5, wherein the parisons comprise a neck connected to an open end of the body, and the parisons are supported by their necks in the holes in the trays, and wherein a closed end of a parison nests within an open neck of an adjacent lower parison.

7. The method of claim 5, wherein each tray is similar and comprises a plurality of holes larger than a size of the parison body and smaller than a size of the neck, and each tray comprises legs extending vertically to support one tray on top of another.

8. The method of claim 5, wherein each tray includes one or more holes matching a size of a vertically placed alignment arm extending upright from a base.

9. The method of claim 5, wherein the parisons are substantially 100% polyethylene terephthalate.

10. The method of claim 5, wherein the saturating gas is substantially 100% carbon dioxide.

11. The method of claim 5, wherein a closed end of one parison does not touch the inside of a neck of an adjacent parison when nested.

12. The method of claim 5, wherein a parison includes a neck with a ridge that supports the parison from the tray.

13. A method for saturating parisons with a saturating gas sufficient to foam when heated, comprising:
stacking trays containing horizontally aligned parisons, wherein each parison has a body with two ends, and each parison is supported by both ends with a first perforated loading tray at one end and a second perforated lid tray at the other end;
placing the parisons assembled on the trays in a pressure vessel, wherein the longitudinal axes of the parisons are substantially horizontal;
pressurizing the pressure vessel with a saturating gas; and
saturating the parisons with the gas sufficient to create cells in the parisons when heated.

14. The method of claim 13, wherein each parison comprises a neck connected to an open end of the body and a closed end, and wherein the first loading tray supports the necks of parisons and the second lid tray supports the closed ends of parisons, and wherein the closed end of a parison nests within an open neck of an adjacent parison.

15. The method of claim 13, wherein the first perforated loading tray has holes larger than the second perforated lid tray.

16. The method of claim 13, wherein the first perforated loading tray comprises support legs to rest on an adjacent perforated lid tray, and the lid tray comprises a rim around a periphery that extends perpendicular to the lid tray, wherein the rim fits on the periphery of an adjacent first loading tray.

17. The method of claim 13, wherein the parisons are substantially 100% polyethylene terephthalate.

18. The method of claim 13, wherein the saturating gas is substantially 100% carbon dioxide.

19. The method of claim 13, wherein each parison has a closed end and an open end with a neck, and the closed end of one parison does not touch the inside of the neck of an adjacent parison when nested.

20. A method for saturating parisons with a saturating gas sufficient to foam when heated, comprising:
placing a gas-unsaturated parison in a pressure vessel individually;
pressurizing the pressure vessel with the parison with a saturating gas;
periodically re-pressurizing the pressure vessel as the parison absorbs the gas;
transferring the pressure vessel with the parison for a period sufficient to achieve a concentration of gas sufficient to create cells in the parison when heated; and
removing the gas-saturated parison from the pressure vessel.

21. The method of claim 20, wherein the parison is substantially 100% polyethylene terephthalate.

22. The method of claim 20, wherein the saturating gas is substantially 100% carbon dioxide.

23. The method of claim 20, wherein the parison comprises an elongated body portion closed at one end and a neck portion of a larger diameter connected to an open end of the body portion.
